(19) United States
(12) Patent Application Publication
(10) Pub. No.: US 2005/0003854 A1
(43) Pub. Date: Jan. 6, 2005

(54) Single user device for receiving voice, text, video and graphical data from both wireless and wire-lined networks

(76) Inventors: Vijay K. Sharma, Morgan Hill, CA (US); Ron Anglikowski, Morgan Hill, CA (US); Mark Sova, San Jose, CA (US)

Correspondence Address: Vijay K. Sharma, 105 Cochrane Circle, Morgan Hill, CA, 95037, US

(21) Appl. No.: 10/609,760

(22) Filed: Jul. 1, 2003

(51) Int. Cl. H04M 1/00; H04B 1/38

(52) U.S. Cl. 455/552.1; 455/550.1

(57) ABSTRACT

The method and apparatus of the present invention enable the use of a single wireless mobile user communications device to transact communications sessions using a plurality of communication modes, both wireless and wire-lined. The single wireless mobile user communications device is comprised of a reduced instruction set processing unit, a digital signal processor unit, a novel multi-mode tunable transceiver, and a memory to direct operation of the communications device in such a way that the transceiver continuously samples a plurality of wireless communication modes, and upon receiving a request to establish a communications session, selects the one of the plurality of communication modes having the optimum signal characteristics as the transaction medium for that particular communications session.

This non-provisional patent application is related to provisional patent application 60/392,622 filed on Jun. 28, 2002.

### BRIEF DESCRIPTION

The subject of this invention relates to the communications industry. Specifically, this invention concerns a multi-mode digital communications device capable transacting a plurality of data types using a plurality of communications protocols.

### BACKGROUND OF THE INVENTION

Humans have needed to communicate over distances for all of history. Over that history the methods used have improved, but the object is the same: send and receive information. Early man undoubtedly used numerous methods including shouting and smoke. Later, for example during the time Roman Empire was using its armies to expand over most of Europe, flag signals were used to control movements of troops. These methods remained essentially unchanged until the early part of the 19^{th} century.

Of course modern communications are based on electricity. In 1825, British inventor William Sturgeon demonstrated the electro-magnet, laying the foundation for large scale electronic communication. Then, in 1830, the American Joseph Henry demonstrated the first telegraph by sending a signal over a mile of wire. But it wasn't until 1843 that a publicly funded stretch of 40 miles of wire from Washington D.C. to Baltimore operating the Morse Code proved that a telegraph system could work.

The telegraph became the main form of distance communication, including a trans-Atlantic cable. Wires ran across the continent along rail corridors, providing rapid and reliable communication from very distant parts of the nation. But in 1875 Alexander Graham Bell demonstrated the first device that was capable of passing voice data over a wire. With the birth of the telephone, electronic communication rapidly expanded into homes and offices.

The Public Switched Telephone Network, or PSTN, as we know it today was the result of the continuous improvement in devices and expansion of the wire-lined network. But in the 1930s mostly as a result of the need for rapid, remote and wireless battlefield communications, the radio-telephone began to emerge. The earliest versions were truly radios, but as time passed and the emergence of the semiconductor allowed extreme size and weight reductions, the devices became smaller and less expensive. Again propelled by technological advances including increases in frequencies and deployment of remote relay stations, the modern cell phone network appeared.

Current developments in the communications industry include the merging of technologies. For example, cell phones, computers, PDAs and intelligent remote reporting devices such as electric meters are all beginning to have similar capabilities. Laptop computers are capable of connecting to local wireless networks via the 802.11 wireless standard as well as connecting to the Internet via the cell phone network or a land line. As these technologies continue to merge, they are also becoming cross functional. Cell phones now have the ability to browse the Internet and receive video data as well as voice communications.

But as these technologies advance and merge, integration remains a problem. Thus if a user wishes to make a cell phone call he or she must use a cell phone. Likewise, if that same user wishes to continue the cell phone call but has a need to leave an environment where the cell signal is sufficient, they must either hang up and reconnect using a land line phone or must simply let the call drop. What is needed is a method and apparatus that provides a plurality of connectivity modes and that can seamlessly move between these modes without dropping a communications session in progress. The method and apparatus of the present invention accomplish this and other goals and objectives described below in detail.

### SUMMARY OF THE INVENTION

The method and apparatus of the present invention enable the use of a single wireless mobile user communications device to transact communications sessions using a plurality of communication modes, both wireless and wire-lined. The single wireless mobile user communications device is comprised of a reduced instruction set processing unit, a digital signal processor unit, a novel multi-mode tunable transceiver, and a memory to direct operation of the communications device in such a way that the transceiver continuously samples a plurality of wireless communication modes, and upon receiving a request to establish a communications session, selects the one of the plurality of communication modes having the optimum signal characteristics as the transaction medium for that particular communications session.

Use of the present invention also provides a user with the ability to transact a plurality of data types including graphical, text and voice. Due to the unique and novel combination of components, the single wireless mobile communications device, in cooperation with a communications server, is capable of receiving from and transmitting to older, so called legacy equipments such as a standard telephone set. Thus the single wireless mobile communications device of the present invention can operate as the user's terminus for a plurality of other devices such as a home phone, a cellular telephone, and an office phone. The communications sessions normally associated with each of these multiple devices may now be transacted using a single device, thereby greatly simplifying and economically improving the communications process.

In operation, a memory contained within the single user communications device includes a network protocol manager module, a call manager module, a media manager module, a communications mode manager module, and a transceiver control manager module as well as the more customary user interface and system functions control. In combination, these modules are interoperably connected to act to direct the operation of the single wireless user communications device by causing the network protocol manager module to identify the single wireless user communications device to a communications server, if present, and then transact communications sessions over a wireless network under the control of the call manager module in combination with the media manager module and the communications mode manager module. Absent the communications server, the single user communications device will select the best one of a plurality of communications modes, as indicated by best signal strength, for transacting a communications session.

### BRIEF DESCRIPTION OF THE DRAWINGS

FIG. 1: shows a diagram of a system that can make use of the method of the present invention.

FIG. 2: provides a detailed block diagram of a single wireless user communications device that can be used with the method of the present invention.

FIG. 3A: shows an overall state diagram of the single wireless user communications device process that can make use of the method of the present invention.

FIG. 3B: shows details of the Call Management state of the single wireless user communications device process used in one embodiment of the present invention.

FIG. 3C: shows details of the Session Control state of the single wireless user communications device process used in one embodiment of the present invention.

FIG. 3D: shows details of the Error state of the single wireless user communications device process used in one embodiment of the present invention.

### DETAILED DESCRIPTION OF PREFERRED EMBODIMENTS

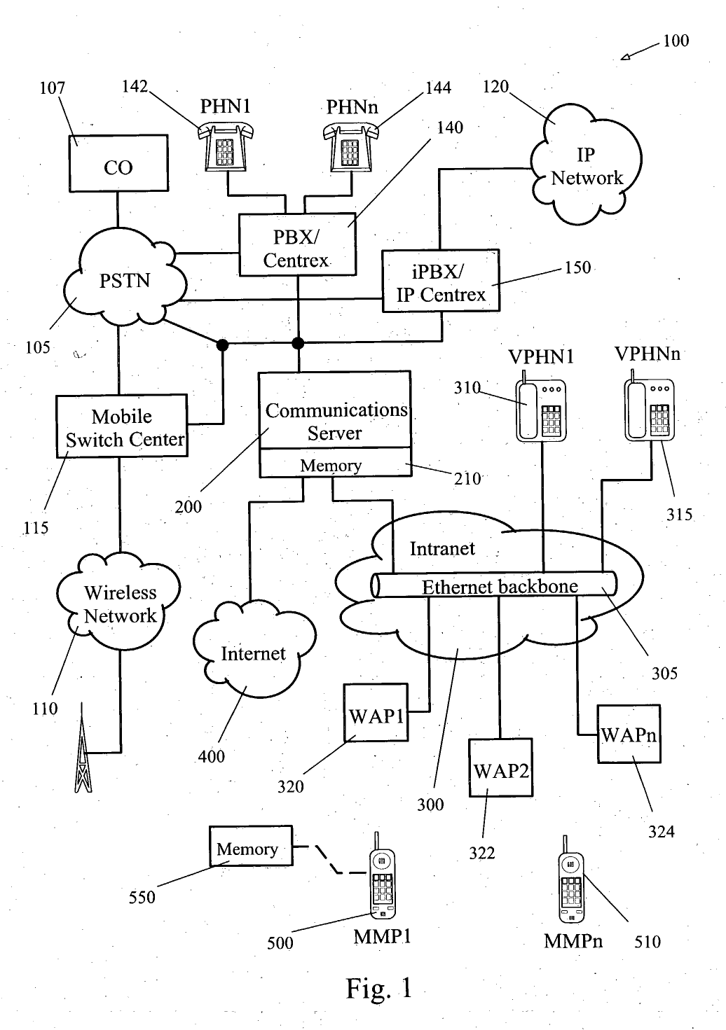

FIG. 1 presents a system 100 showing a preferred embodiment of the present invention. A Communications Server 200 is connected to a plurality of networks including Intranet 300, Internet 400, IP Network 120, Public Switched Telephone Network [PSTN] 105, and Wireless Network 110. Communications Server 200 connects to the PSTN 105 either directly, or via PBX/Centrex 140, and from the PSTN 105 to the Central Office [CO] 107. The Communications Server 200 also connects to Wireless Network 110 either via PSTN 105 or directly to the Mobile Switching Center 115. Each of these connections is made in the customary manner and thus is not discussed in detail to aid in clarity. Also connected to the Communications Server 200 via PBX/Centrex 140 are a plurality of Customer Premises Equipments [CPE] PHN1 142 through PHNn 144. The PBX/Centrex 140 and CPEs PHN1 142 through PHNn 144 are so called legacy equipments because they employ older technology. However, since these devices are still in wide use, the method of the present invention advantageously accommodates these legacy equipments.

IP Network 120 connects to the Communications Server 200 via iPBX/IP Centrex 150. The iPBX/IP Centrex 150 is the modern equivalent of the legacy equipments discussed above. These newer Private Branch Exchanges [PBX] offer a broader range of services to users, for example, Voice Over IP [VOIP]. iPBX/IP Centrex 150 also connects directly to the PSTN 105 as was the case for the legacy PBX above. The method and apparatus of the present invention offers the advantage of connecting to both modern and legacy systems.

Still referring to FIG. 1, and looking more closely at Intranet 300, in a preferred embodiment of the present invention an Ethernet backbone 305 is used to provide the protocol for passing data communications between devices attached to the network. While the method of the present invention uses an Ethernet protocol, this is not the only protocol that could be used, thus this should not be read as a limitation on the scope of the invention.

Also connected to the Ethernet backbone 305 are a plurality of Internet compliant telephones VPHN1 310 through VPHNn 315. These so called iPhones have the ability to display text and graphics as well the customary voice services of a standard telephone. As described in greater detail below, the Communications Server 200, via its internal Memory 210, has the ability to manage communications sessions between the iPhones VPHN1 310 through VPHNn 315 and other communications devices including both wire-lined and wireless devices.

In a preferred embodiment of the present invention Intranet 300 is a Local Area Network [LAN], for example, a network confined to the area within a business. Wireless Access Points WAP1 320, WAP2 322 and WAPn 324 are attached to the Ethernet backbone 305 in the customary manner. Upon receiving low power radio communications from a compatible wireless device, the wireless access points WAP1 320, WAP2 322 and WAPn 324 transfer the data to the Communications Server 200 for processing. Conversely, data from the Communications Server 200 may be sent to compatible wireless devices via Wireless access points WAP1 320, WAP2 322 and WAPn 324. In a preferred embodiment, the wireless network uses the 802.11 communications standard, but this is not the only wireless standard that may make use of the method of the present invention, thus use of this standard should not be read as a limitation on the scope of the invention.

Further, while in the preferred embodiment the Intranet 300 is confined to a business, there are other applications, for example, at airports, that could make use of the method of the present invention, thus use inside a business should not be read as a limitation on the scope of the invention. And while in the preferred embodiment the PBX/Centrex 140 and the iPBX/Centrex 150 are standalone devices, there is no reason that the functions of these devices could not be integrated into the Communications Server 200 architecture, providing both space and efficiency gains.

For the method of the present invention, one preferred wireless device is a single user communications device such as MMP1 500 through MMPn 510. In a preferred embodiment of the present invention, MMP1 500 through MMPn 510 are multi-mode wireless communications devices. As such, these devices continually scan known wireless protocols seeking presence of compatible signals. Upon finding a compatible signal, the strength of that signal is stored for future reference and the scan continues. In this way, MMP1 500 through MMPn 510 are constantly aware of the best signal to be used at any given point in time. Information about the strength of various signals as well as other data and programming code are maintained in Memory 550 within each of the MMP devices. Note that while the single user device discussed in conjunction with the method of the present invention is a multi-mode phone, other devices could be used without departing form the spirit of the invention, for example, PDA, laptop computers, or data entry devices such as point-of-sale [POS] terminals.

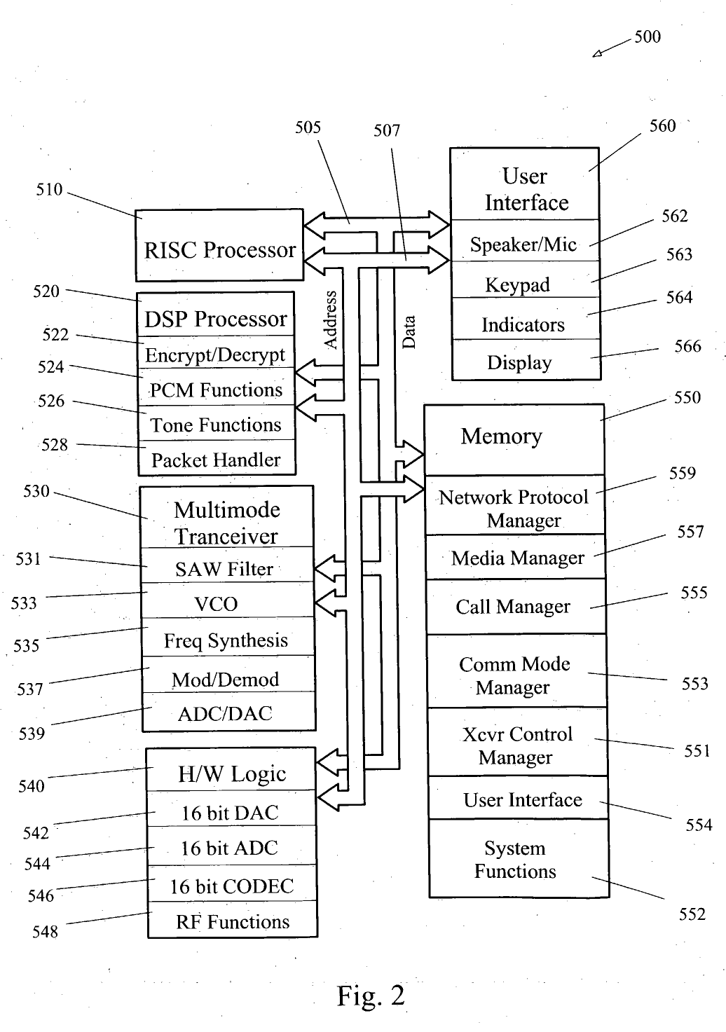

Referring now to FIG. 2, a detailed block diagram 500 of a multi-mode communication device, or multi-mode phone that can be used with the method of the present invention is shown. Note that the configuration shown is exemplary only. There are many other configurations that may have some or all of the features of the exemplary device, thus use of this configuration should not be read as a limitation on the scope of the invention. For the balance of the discussion the terms “single wireless user communications device,” “multi-mode communication device,” and “multi-mode phone” will indicate the same device, and will be denominated as an MMP.

Reduced Instruction Set Computer [RISC] processor 510 communicates with other functional blocks via data and address buses 505 and 507 respectively. User Interface 560 contains those functions necessary to allow a user to operate the device including a Speaker/Mic interface 562, Keypad interface 563, Indicators interface 564 and Display interface 566. Each of these operate in the customary manner and do not directly impinge on the operation of the present invention thus are not described in detail to aid in clarity. In a preferred embodiment, the RISC processor 510 is an ARM9XX from Arm Ltd. of Cambridge, UK.

Digital Signal Processor [DSP] 520 contains those function required to process the different data types that the multi-mode phone 500 may be required to process. Included are Encryp/Decrypt function 522, Pulse Code Modulation [PCM] function 524, Tone function 526 and Packet Handler function 528. Encryp/Decrypt function 522, Pulse Code Modulation [PCM] function 524 and Tone function 526 accomplish their customary functions. Packet Handler 528 is required to accommodate the newer data types that communications devices are capable of using, for example, data sourced on an Ethernet network. In a preferred embodiment, the DSP 520 is an C5470 from Texas Instruments Incorporated of Dallas, Tex.

The heart of the multi-mode phone 500 is the Multimode Transceiver 530. Since the multi-mode phone 500 is required to transact data over a plurality of network mediums, for example, 802.11 wireless networks and PCM cellular networks, a SAW Filter 531, Voltage Controlled Oscillator [VCO] 533 and Frequency Synthesizer 535 work in concert to facilitate these different network communication standards. In a preferred embodiment the SAW Filter 531 is a 8546XX from TRIQuint Semiconductor, Inc. of Beaverton, Oreg. while the VCO 533 is a MQE/MQL/MQK series from Murata Manufacturing Co., LTD of Kyoto, Japan. Modulator/Demodulator 537 and Analog-to-Digital/Digital-to-Analog [ADC/DAC] 539 perform customary functions. In a preferred embodiment the ADC/DAC 539 is a TLC320 series from Texas Instruments Incorporated of Dallas, Tex.

The balance of the block diagram consists of the Hardware [H/W] Logic 540 and the Memory 550. H/W Logic 540 is comprised, generally, of a 16 bit DAC 542, for example, a ADS100 from Texas Instruments Incorporated of Dallas, Tex., a corresponding 16 bit ADC 544, for example a DAC1221 also from Texas Instruments Incorporated of Dallas, Tex., a 16 bit CODEC (coder/decoder) 546 and the Radio Frequency [RF] functions 548 required for wireless operation. In a preferred embodiment the CODEC 546 is a TLC320AD545 from Texas Instruments Incorporated of Dallas, Tex. The 16 bit DAC 542, a corresponding 16 bit ADC 544, a 16 bit CODEC (coder/decoder) 546 are used to accomplish the audio processing and speech functions needed by the multi-mode phone 500. The RF functions 548 accomplish the necessary radio frequency fuctions.

Memory 550 is comprised of the necessary software instructions needed to operate the multi-mode phone portion of the method of the present invention, for example, MMP1 500 of FIG. 1. Note that such data as housekeeping program modules, user programmable data and other data normally associated with a digital server device are not shown since they do not directly impinge on the method of the present invention. However, as these modules are customary, their absence should not be read as a limitation on the scope of the invention. Each of the seven software program modules shown are each discussed in detail below.

Transceiver Control manager module 551 provides the software functions necessary to operate the multi-mode transmitter/receiver. The transceiver is instructed to tune to the various carrier frequencies of known compatible wireless protocols in succession, for example, CDMA, PCM and 802.11. Still under the control of Transceiver Control module 551, the MMP1 500 determines if any of the selected carrier frequencies are present. Upon detection of a signal, the strength of the signal is stored to Memory 550 for use as a potential communications medium. The three communications protocols indicated above are not the only communications modes that MMP1 500 could scan, thus this should not be read as a limitation on the scope of the present invention.

Network Protocol Manager 559 within Memory 550 contains the necessary software instructions to configure MMP1 500 to exchange data over a plurality of network protocols based upon which of a plurality of communications modes has been selected by the Call Manager module 555. For example, if Call Manager module 555 has selected 802.11 as the optimum communication mode for MMP1 500, Network Protocol Manager 559 will set TCP/IP (Transmission Control Protocol/Internet Protocol) as the protocol for the duration of the session.

Call Manager module 555 provides the necessary operating instructions to select which of the plurality of wireless communications modes to use for a particular communications session and provides the coordination needed for proper formatting of the various data types associated with the plurality of protocols. For example, if Call Manager module 555 has selected 802.11 as the optimum communication mode for MMP1 500, Network Protocol Manager 559 will set TCP/IP as the protocol for the duration of the session as described above. Depending upon what type of data is being transacted during the communications session, the Call Manager module 555 coordinates with other resident software modules to properly format and present the data to the user. For example, the communications session may include a combination of graphical data, text data and voice data, all of which will be properly formatted for presentation to the user.

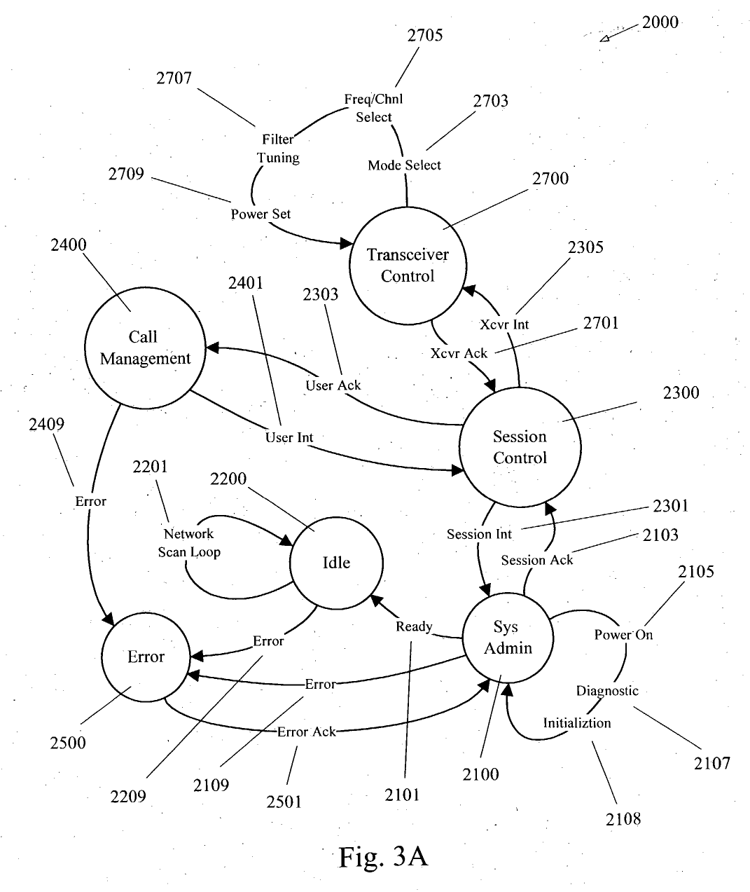

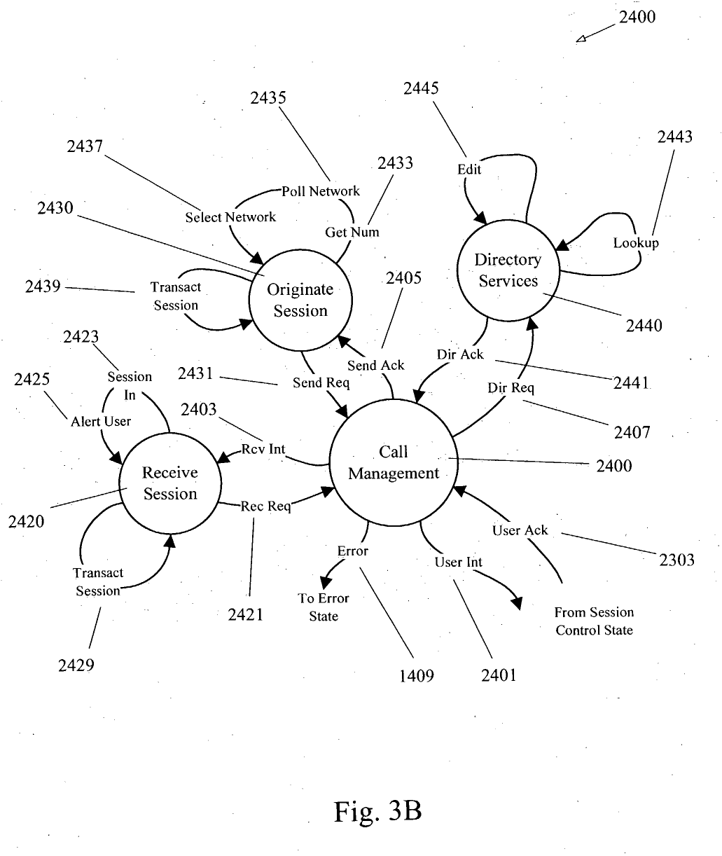

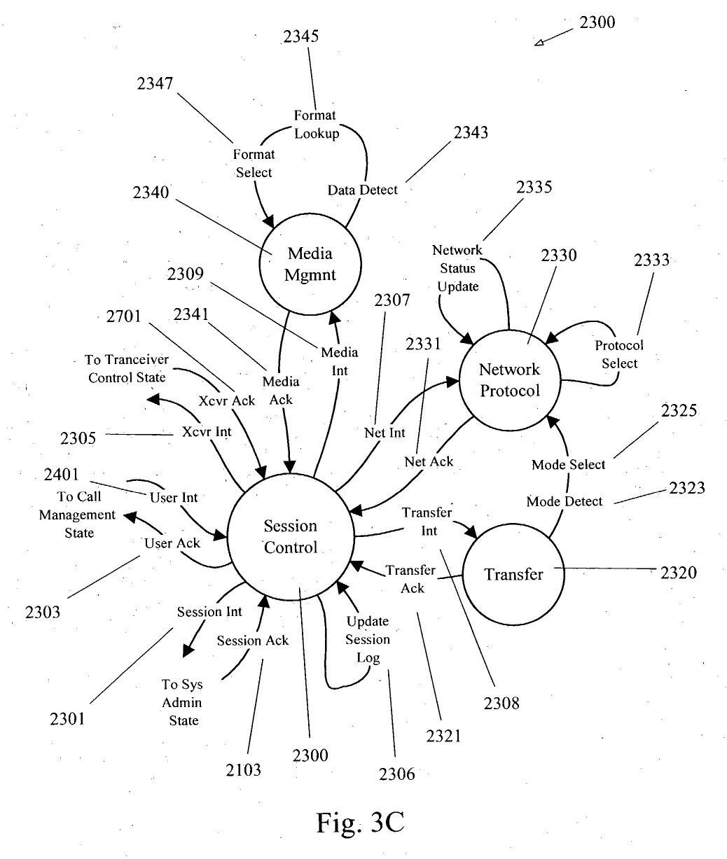

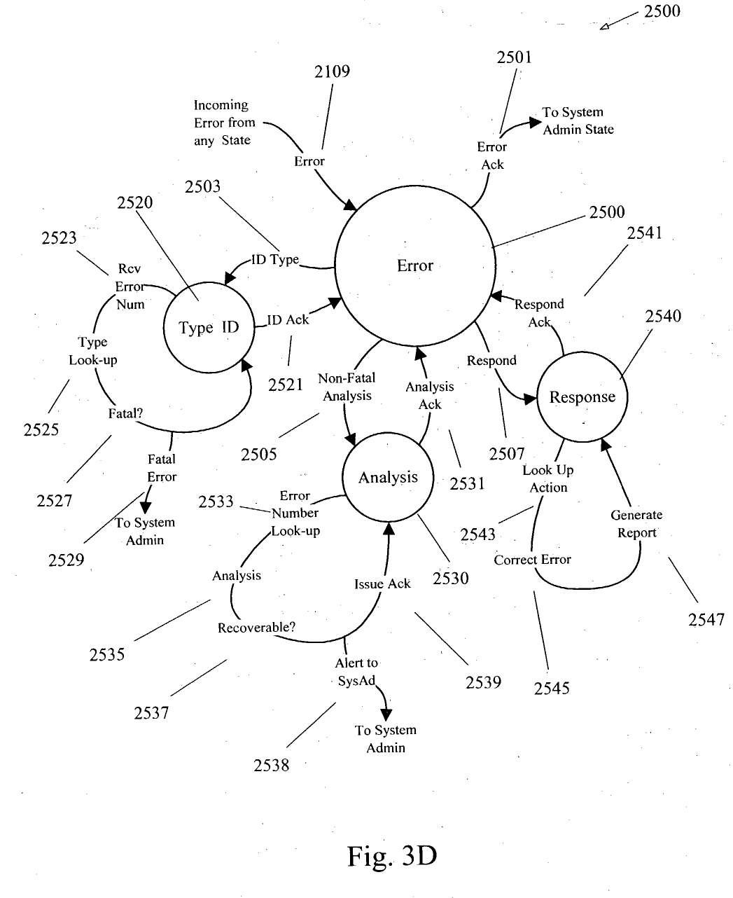

Also contained in Memory 550 of FIG. 3 is a User Interface module 554. This module contains the necessary software instructions to cause a communications device such as MMP1 500 to operate display device functions such as driving a display screen or reading keypad input. Media Manager module 557 is responsible for presenting the various types of data being received on the MMP1 500. If a user receives a call from a video capable device, for example, a cell phone with a camera, the video image needs to be manipulated for presentation on the MMP1 500 screen.

Communication Mode Manager module 553 works with the Network Protocol Manger module 559 and the Transceiver Control Manager module 551 to properly configure the MMP1 500 for the various communication modes. System Functions module 552 accomplishes the general housekeeping and administrative functions associated with a digital communications device such as MMP1 500. These functions are well understood and are not discussed in detail to aid in clarity, however, absence of a detailed discussion should not be read as a limitation ion the scope of the invention.

Because the operation of the system is distributed among several major components, an operational discussion of the method of the present invention is best handled by a series of state diagrams. FIGS. 3A through 3D present the operational details of the MMP 500 of FIG. 1. It will be understood that although the figures are discussed separately, the software instruction modules contained within the memory of MMP1 500 are constantly interacting to accomplish execution of communications sessions thus discussion of these devices separately does not imply a single operational scenario. Rather, as the operational scenario varies, the software modules will execute alternate paths to service the alternate scenario.

For the discussion of FIGS. 3A through 3D it will be assumed that a communications server, such as communications server 200 of FIG. 1, is available and that the MMP 500 is registered with the server. In the absence of a communications server, the MMP 500 will operate as a stand-alone wireless communication device, so the absence of a communications server should not be taken as a limitation on the scope of the invention.

Looking at FIG. 3A a top level state diagram 2000 of the MMP is shown. The Sys Admin state 2100 provides the general process control and is responsible for start-up of the multi-mode device. When the user turns the device on a Power On signal 2105 causes a self testing diagnostic routine to execute at Diagnostic 2107. Once the diagnostic has successfully completed the MMP is initialized at Initialization step 2108. The Sys Admin state 2100 then sends a Ready signal 2101 to the Idle state 2200 which indicates that the MMP is ready to transact communications sessions. If at any time during the power up, diagnostic or initialization of the MMP an error occurred, Error signal 2109 passes control to the Error state 2500, discussed in detail below.

Once in the Idle state 2200 the method of the invention enters a loop that constantly scans for available communication modes via the Network Scan Loop 2201. This is done by varying the receiver frequency and testing for the presence of a signal. As signals are discovered the parameters of the network, such as slot frequency and signal strength, are logged into a data base for later use by the Session Control state 2300 and the Call Management state 2400. At this time the MMP is ready to transact communications sessions. If at any time an error occurs, Error signal 2209 passes control to the Error state 2500, discussed in detail below.

The MMP will remain in the Idle state 2200 until one of two events occurs: either an outgoing session is initiated by the user or an incoming session is detected by the MMP. Both of these events are under the control of the Call Management state 2400. While the Call Management state 2400 is discussed in detail later, for now it is enough to explain that in either event an interrupt is generated at User Int 2401. This interrupt is used to trigger several control events within the Session Control state 2300 and the Transceiver Control state 2700. The processes associated with these states select the appropriate network for a particular session and adjust the characteristics of the MMP to use the proper communications medium. These processes are explained in detail below. Once completed, the Session Control state 2300 passes control back to the Call Management state 2400 via the User Ack signal 2302. As with the earlier states, the occurrence of an error occurs causes Error signal 2409 to pass control to the Error state 2500, discussed in detail below.

Session Control state 2300 passes data and control between the Sys Admin state 2100, the Transceiver Control state 2700 and the Call Management state 2400. As detailed below, upon receiving a User Int interrupt 2401, a Xcvr Int 2305 passes control to the Transceiver Control state 2700. In this state a Mode Select routine 2703 is used to determine the appropriate communications mode for a given session. Then the MMP transceiver frequency and channel are set at Freq/Chnl Select 2705, the various filters are set at Filter Tuning 2707 and the appropriate power level for the selected communications medium set at Power Set 2709. After the MMP is correctly configured, control returns to the Session Control state 2300 via the Xcvr Ack signal 2701.

With the MMP transceiver properly set and either an incoming or outgoing session ready, the Session Control state 2300 passes control to the Sys Admin state 2100 via the Session Int interrupt 2301. The Sys Admin state 2300 proceeds to interact with a Communications Server (200 in FIG. 1,) if present, to transact the session. Once the session has been established, the Session Ack signal 2103 returns control to the Session Control state 2300. The Error state 2500 issues the Error Ack signal 2501 returning control to the Sys Admin state 2100.

Turning to FIG. 3B, the Call Management state 2400 is shown in detail. Assume that the MMP is in the Idle state 2200 and the user of the device wishes to originate a communications session. Control passes to the Originate Session state 2430 and a destination number is generated in one of a number of ways in the customary manner. By way of example, the user may key in the number on the keypad of the MMP, or in the alternative, may press a speed dial key causing the MMP to do a lookup in the directory. In any event, the Get Num signal 2433 launches the Poll Network routine 2435. This routine scans the available networks to determine the best communications mode for the current session. At Select Network 2437 the best mode is selected and the number queued for dialing.

When the destination number has been queued a request to send the call is passed to the Call Management state 2400 via the Send Req interrupt 2431. The Call Management state 2400 then issues a User Int interrupt 2401 informing the Session Control state 2300 that an outbound call is pending. As will be discussed in detail below in conjunction with FIG. 3C, Session Control state 2300 operates to configure the MMP properly for the communications mode selected by Select Network 2437. When the transceiver is properly configured, a User Ack interrupt 2303 is passed back to the Call Management state 2400 which in turn passes control to the Originate Session state 2430 via the Send Ack interrupt 2405. The session is then transacted by the Transact Session routine 2439 in the customary way. Since communication session transactions are well understood, no detailed discussion is presented here for clarity; however, absence of such a detailed discussion should not be read as a limitation on the scope of the invention.

Suppose now that instead of originating a call, the MMP receives a signal that an incoming session has arrived. Since the MMP is responding to a signal present in the environment, there is no need to configure the transceiver. Instead, the Session In signal 2423 launches the Alert User routine 2425. This routine is responsible for annunciating a ringer tone, writing incoming data to a screen, for example, caller ID data, and/or switching on a silent alert such as a vibrator. In response the user takes an appropriate action, for example, pressing a key, which generates the Rec Req interrupt 2421, passing control to the Call Management state 2400. As with the mechanism for originating a call, a User Int interrupt 2401 passes control to the Session Control state 2300. From there the process follows the discussion from above associated wit the Sys Admin state 2100. Again as with the originate session, a User Ack 2303 interrupt is returned, followed by a Rcv Int interrupt 2403 passing control back to the Receive Session state 2420. The incoming session is then transacted by the Transact Session routine 2429 in the customary way. Since communication session transactions are well understood, no detailed discussion is presented here for clarity; however, absence of such a detailed discussion should not be read as a limitation on the scope of the invention.

Also part of the Call Management state in the MMP is the Directory Services state 2440. The Directory Services state 2440 is entered when a Dir Req interrupt 2407 is generated. This can occur for several reasons, but by way of example, the user may have pressed a speed dial key or the user may be entering or updating directory data. If the request is for data lookup, for example, in order to support an outgoing session, the Lookup routine 2443 is launched. This routine operates in a manner consistent with data lookup algorithms and is thus not discussed here in detail. Once the lookup is complete, control returns to the Call Management state 2400 via the Dir Ack signal 2441.

In a similar manner, the Edit routine 2445 allows the user to enter or modify data in the directory in the customary manner. Note that absence of a detailed discussion of the lookup and/or edit functions should not be read as a limitation on the scope of the invention. Should an error occur at any time while in the Call Management state 2303 or any of the related satellite states an Error signal is generated at Error 1409, causing control to be passed to the Error state 2500. Since the Error state 2500 operates in a manner very similar to the Error state 2500 associated with Communications Server 200, no detailed discussion is provided here. Rather, the reader is directed to the discussion above of Error state 2500 for such a detailed discussion.

FIG. 3C provides the details of the Session Control state 2300. The Session Control state 2300 serves as the central switch for transaction and data flow activities in the MMP. As discussed above, when an outgoing or incoming session requires attention, a User Int interrupt 2401 arrives from the Call Management state 2400. Depending on the type of request, the Session Control state 2300 directs activities to the proper state. If, for example, the request is for an outgoing session, an Xcvr Int interrupt 2305 passes control to the Transceiver Control state 2700 discussed earlier. Once the Tranceiver Control state has accomplished its function an Xcvr Ack interrupt 2701 returns control to the Session control state 2300.

In the case of an incoming session request the same process flow is followed except that a Media Int interrupt 2309 passes control to the Media Management state 2340. The function of this state is to detect and then format incoming data for the MMP. For example, the MMP is capable of receiving video data and text data, thus the Media Management state 2340 must correctly format the data for display. The data type is detected at Data Detect 2343, then the format is checked at Format Lookup 2345 and then selected at Format Select 2347. When the selection is completed control is returned to the Session Control state 2300 via the Media Ack interrupt 2341.

At various times during the operation of the MMP the network protocol must be detected and/or the status of the plurality of available networks updated. The Network Protocol state 2330 responds to a Net Int interrupt 2307 from the Session Control state 2300. Depending on the nature of the request one of two functions is accomplished. If the request is for a status update, the Network Status Update routine 2335 is used to first poll, then to update the parameters of all the available networks compatible with the MMP. If the request is for transfer of a session from one communication mode to another, for example, in response to determining that an 802.11 wireless signal is weaker than a PCM cellular signal, the Protocol Select loop 2333 is used to make the selection. Regardless of why the state was entered, when the requested task is complete the Net Ack interrupt 2331 passes control back to the Session Control state 2300.

Continuing with the case where a communications session must be transferred, the Transfer state 2320 is entered via the Transfer Int interrupt 2308. The Transfer state 2320 responds with the Transfer Ack signal 2321 to inform the Session Control state that a transfer will be accomplished. Then the Mode Detect task 2323 is launched to poll for the best communication mode to transfer to followed by a network selection at Mode Select routine 2325. Process flow then enters the Network Protocol state 2330 discussed just above.

Each time a session is initiated, whether outgoing or incoming, a session ID is assigned. Once the session ID has been assigned, the Update Session Log routine 2309 refreshes the session log data. Also as was discussed above, the Session Control state 2300 issues a Session Int interrupt 2301 at various times to pass control to the Sys Admin state 2100. The Session Ack signal is used by the Sys Admin state 2100 to return control to the Session control state 2300. In a like manner, the User Int interrupt 2401 and the User Ack signal 2303 are used to pass control to and from the Call Management state 2400.

The Error state 2500 appears in detail in FIG. 3D. As described in detail above, the Error state 2500 is entered via an error interrupt, for example, Error interrupt 2109 from the Sys Admin state 2100. Note that the incoming Error interrupt 2109 is exemplary only and could be any error interrupt from any state. Upon entering the Error state 2500 three tasks are performed: error type identification, error analysis and error response generation. Depending upon the exact nature of the error, the system may be able to recover and continue operations. If not, the system is shut down in a controlled manner.

The error type identification takes place in the Type ID state 2520 and is entered via ID Type signal 2503. An error number, generated by the reporting state, is logged at Rcv Error Num step 2523. At Type Look-up step 2525 the number is compared to a table of errors to determine if it is fatal or not. At Fatal? 2527 a decision is made as to the nature of the error. If the error is not fatal the system will be able to recover so control passes back to the Error state 2500 via the ID Ack signal 2521. If the error is fatal the Fatal Error signal 2529 passes control to the Sys Admin state 2100 which then executes a controlled shut down of the system.

Once an error type has been determined the Analysis state 2530 is entered via the Non-Fatal Analysis interrupt 2505. The reported error number is retrieved at Error Number Look-up 2533 and an analysis of the error accomplished at Analysis step 2535. As will be recognized, the exact nature of the analysis will depend on the nature of the error, but in general, reported error numbers and parameters related to the error are considered by the analysis routine. The outcome of the analysis will be a recoverable or non-recoverable state. That decision is made at Recoverable? 2537. If the error is recoverable, an Issue Ack signal 2539 informs the Error state 2500 via the Analyzed Ack signal 2531 which then initiates the recovery process. The Error state 2500 then provides the necessary handshake with the rest of the system to allow the recovery process to proceed. If the error was not recoverable, an Alert to SysAd signal 2538 is sent and control passes to the Sys Admin state 2100 to begin the error logging and reporting procedure. The error reporting and logging procedure is used to provide data for system administrators because, although the error was not fatal, it may be beneficial to understand why the error occurred.

The error recovery process is begun when the Error state 2500 issues a Respond interrupt 2507. Control is passed to the Response state 2540. The Response state 2540 completes a determination of the recovery actions required at Look Up Action 2543. The error is then corrected at Correct Error 2545 and a internal report generated at Generate Report 2547. This report is used later by system administrators to assist in locating faulty or failing components. The Response state sends the Respond Ack interrupt 2541 to the Error state 2500 to complete the recovery process.

From the above detailed discussion of the figures it will be recognized that a first advantage of the method of the present invention is the ability to interact with a communications server to transfer an active communications session between a plurality of different networks and protocols. This transfer occurs seamlessly and remains hidden to the user, so no user intervention or action is required. Thus a user could originate or receive a call from a third party over a CDMA cellular network, move to an area covered by a more viable 802.11 wireless signal and have the session continue uninterrupted.

A second advantage of the present invention is that it provides a single user device capable of communicating with a broad variety of network protocols. Thus if the user is in proximity to a cellular network, for example a PCM network, and if that signal is stronger than other signals present at the same time, the user device will take advantage of the stronger signal to transact communication sessions.

A third advantage of the present invention is that a single user device may take the place of several other devices. Since the device is capable of receiving communications over a plurality of networks, whether assisted by a communications server or not, and since it can select one of a number of protocols, the user simply needs one device instead of the numerous devices required by the current art.

A fourth advantage of the present invention is that it is capable of communicating over legacy networks such as the wire-lined PSTN when assisted by a communications server. As such, it allows older systems to continue in use mitigating the requirement for investment in newer systems.

A fifth advantage of the present invention is that it improves user efficiency and economics. Since there is only one device, and since it automatically selects the optimum network for communication sessions, the user is free from the need to program and/or reconnect as the network signals present change. The present invention is economically advantageous since only one device is required, thus only one purchase is required.

1. A multi-mode hand held communications device comprising:
a reduced instruction set processing unit;
a digital signal processor unit;
a multi-mode tunable transceiver, and;
a memory to direct operation of a digital device in such a way that said multi-mode tunable transceiver, operating under instructions from said reduced instruction set processing unit, continuously samples a plurality of wireless communication modes, storing characteristics of said wireless communication modes, and upon receiving a request to establish a communications session, selects the one of said plurality of wireless communication modes having the optimum characteristics as the transaction medium for said communications session.

2. The multi-mode tunable transceiver of claim 1 where the plurality of wireless communications modes includes at least CDMA wireless cellular telephone, TDMA wireless cellular telephone, PCM wireless cellular telephone, analog wireless cellular telephone and 802.11 wireless local area network.

3. A multi-mode hand held communications device comprising:
a reduced instruction set processing unit;
a digital signal processor unit;
a multi-mode tunable transceiver, and;
a memory to direct operation of a digital device such that a plurality of data types may be transacted with a plurality of wireless communication modes said plurality of wireless communication modes having different protocols.

4. The multi-mode hand held communications device of claim 3 wherein the plurality of data types able to be transacted consists of at least voice data, graphical data and text data.

5. The multi-mode hand held communications device of claim 3 wherein the different protocols associated with the plurality of wireless communication modes consists of at least DTMF protocol, TCP/IP protocol, and CDMA IS-95 protocol, TDMA IS-136 protocol, and IEEE 802.11 protocol.

6. A memory to direct operation of a multi-mode hand held communications device comprising:
a network protocol manager module;
a call manager module;
a media manager module;
a communications mode manager module, and;
a tunable transceiver control manager module operably interconnected in such a way as to cause said tunable transceiver control module to continuously scan for available wireless communication modes, store the characteristics of said available wireless communication modes in the memory of the multi-mode hand held communications device, select, when required, the most optimum of said available wireless communications modes for transacting a particular communications session using said selected one of said available wireless communication modes under the control of said call manager module in combination with said media management module and said communications mode manager module.

7. A memory to direct operation of a multi-mode hand held communications device comprising:
a network protocol manager module;
a call manager module;
a media manager module;
a communications mode manager module, and;
a tunable transceiver control manager module operably interconnected in such a way as to cause said network protocol manager module to identify a multi-mode hand held communications device to a communications server and, said multi-mode hand held communications device having identified itself to said communications server, transact communications over a wireless network under the control of said call manager module in combination with said media management module and said communications mode manager module.

8. A multi-mode hand held communications device communications device connected to and conversant with a communications server wherein said communications server is simultaneously connected to and conversant with a plurality of wire-lined and wireless networks comprising:
a reduced instruction set processing unit;
a digital signal processor unit;
a multi-mode tunable transceiver, and;
a memory to direct operation of a multi-mode hand held communications device such that said memory cooperates with a communications server, said multi-mode hand held communications device having identified with said communications server and configured to communicate with any of said plurality of networks connected to said communications server at any time such that after having been contacted by a specific one of said plurality of networks and having established a communications session the signal of said specific one of said plurality of networks becomes less reliable than the signal of a second one of said plurality of networks, said communications server and said multi-mode hand held communications device cooperating to transfer said established communication session from the first specific one of said plurality of networks to the second one of said plurality of networks without the knowledge of the user and without disrupting said established communication session.
